(19) United States
(12) Patent Application Publication
(10) Pub. No.: US 2015/0079959 A1
(43) Pub. Date: Mar. 19, 2015

(54) Smart Microphone

(71) Applicant: AT&T Intellectual Property I, L.P., Atlanta, GA (US)

(72) Inventors: David Daudelin, Bradley Beach, NJ (US); Pamela Kanal, Oakton, VA (US)

(73) Assignee: AT&T Intellectual Property I, L.P., Atlanta, GA (US)

(21) Appl. No.: 14/026,229

(22) Filed: Sep. 13, 2013

(51) Int. Cl. H04M 3/56; H04W 4/06

(52) U.S. Cl. CPC H04M 3/56; H04W 4/06
USPC 455/416

(57) ABSTRACT

A conference attendee uses a personal communications device such as a smart phone as a microphone to ask questions or otherwise engage in real time communications with other conference attendees and the host, through a speaker system being used in the conference. A server maintains a database of conference attendees, and serves a mobile Web page to each attendee permitting the attendee to request a real-time communication. The server flags records of those attendees that request a real-time communication. The server establishes no voice connection with a personal communications device until after the conference host selects a device from among a number of personal communications devices that have requested communications.

### BACKGROUND OF THE INVENTION

1. Technical Field

The present invention relates to providing microphones in a conference/presentation setting to allow attendees to ask questions or make comments. More specifically, the invention relates to the use of attendees' mobile phones or other portable smart devices as microphones.

2. Discussion of the Related Art

Events such as conferences, meetings and conventions often offer opportunities for attendees and other participants to ask questions or to comment on the proceedings. The term “conference,” as used herein, refers to any such event, and also refers collectively to the host, attendees and other participants of the event. A conference includes live attendees who are present at the conference, and may also include participants who listen to and/or view the conference proceedings via an electronic connection such as a telephone connection or a Webcast.

The questions or comments submitted during a conference are typically broadcast to the conference host and to the attendees through a speaker system such as a public address system, and may also be broadcast to virtual attendees via a traditional or Internet voice connection. Additionally, the questions or comments are frequently recorded as part of an audio or audio/video record of the conference. It is therefore necessary for the attendee asking a question to use a microphone to capture his or her voice signal for transmission to the conference and for recording.

Conference facilities may provide a limited number of wireless microphones that are brought to people asking questions by microphone runners. Alternatively, attendees must get up to ask a question at a microphone stand. In either case, the inconvenience may lead people to refrain from asking questions, or to ask questions without a microphone, making it difficult or impossible for others in the conference to hear, and making it impossible to record the question.

Additionally, special wireless microphones and other hardware must be bought, setup, and maintained by the event hosts. Those activities add costs and complexity to conference hosting.

### SUMMARY OF THE INVENTION

In an exemplary embodiment of the present invention, there is provided a method for broadcasting audio from a selected personal communications device through a speaker system. Before establishing a voice connection with the selected personal communications device, a separate request to broadcast audio through the speaker system is received from each of a plurality of personal communications devices. Also before establishing the voice connection with the selected personal communications device, a selection identifying the selected personal communications device from among the plurality of personal communications devices is received from a conference host computer.

In response to receiving the selection, the voice connection between the conference host computer and the selected personal communications device established. Audio received via the voice connection is then broadcast through the speaker system.

The voice connection may be established using a telephone number associated with the selected personal communications device.

Software installed on the personal communications device that is used in generating the request to address the conference may be limited to a general purpose Web browser. Software installed on the personal communications device that is used in establishing the voice connection may be limited to general purpose telephony software and a general purpose Web browser; and software installed on the conference host computer that is used in establishing the voice connection may limited to a general purpose Web browser.

In one embodiment, a conference identifier is provided to be input into each of the plurality of the personal communications devices. In that case, a separate request to join the conference is received from each of the plurality of personal communications devices, the request including the conference identifier and an identification of the personal communications device. In response to receiving that separate request, an HTML element for making a request to address the conference is transmitted to the personal communications device, and a record corresponding to the personal communications device is created in a database.

Providing a conference identifier may further include visually presenting a two dimensional bar code that, when scanned using a personal communications device, points a browser of the personal communications device to a Web page associated with the conference.

In response to receiving each request to address the conference, a flag may be set in a record of the database corresponding to the requesting personal communications device. A list of records of the database containing a flag indicating a request to address the conference may be presented via the conference host computer. The list of records may be in an order in which the requests to address the conference were received. The identification of the personal communications device may be a telephone number associated with the personal communications device.

In another aspect of the invention, non-transitory computer useable media is provided having computer readable instructions stored thereon for execution by a processor to perform operations as described above.

Another aspect of the invention is a system for broadcasting audio from a selected personal communications device through a speaker system. The system includes a network server including a processor; an audio interface for transmitting signals to be broadcast via a speaker system; a network interface; and a non-transitory computer-usable medium having computer readable instructions stored thereon that, when executed by the processor, cause the processor to perform operations as described above.

### BRIEF DESCRIPTION OF THE DRAWINGS

FIG. 1 is a flow chart illustrating operations comprising one embodiment of the present invention.

FIG. 2 is a block diagram representing the overall architecture of an exemplary embodiment of the present invention.

FIG. 3 is a block diagram representing a sequence of events occurring during a conference setup in an exemplary embodiment of the present invention.

FIG. 4 illustrates a structure of database record representing an event according to an exemplary embodiment of the present invention.

FIG. 5 illustrates a structure of database record representing a participant according to an exemplary embodiment of the present invention.

FIG. 6 is a block diagram representing a sequence of events occurring during participant registration in an exemplary embodiment of the present invention.

FIG. 7 is a block diagram representing a sequence of events occurring when a participant raises his hand in an exemplary embodiment of the present invention.

FIG. 8 shows graphics displayed on a smart device according to an exemplary embodiment of the present invention.

FIG. 9 shows graphics displayed on a presenter's screen according to an exemplary embodiment of the present invention.

FIG. 10 is a block diagram representing a sequence of events occurring when a participant is selected in an exemplary embodiment of the present invention.

FIG. 11 is a schematic diagram of an exemplary system used in implementing the operations of the invention.

### DETAILED DESCRIPTION OF EXEMPLARY EMBODIMENTS

Overview

Described herein is a cloud service allowing conference attendees to use their own mobile devices as microphones to comment or ask questions over the event's speaker system. The conference host begins a session from a conference host computer such as a laptop, which is connected to the audio system. An attendee joins the session from a mobile Website accessed on his mobile smart device, and raises his hand by pressing a button in the Website when he has a question. The attendee is “called on” by the presenter or a moderator from the conference host computer. A new voice connection is then established between the mobile device and the computer, enabling audio to be streamed from the device to the computer and heard on the event's speaker system.

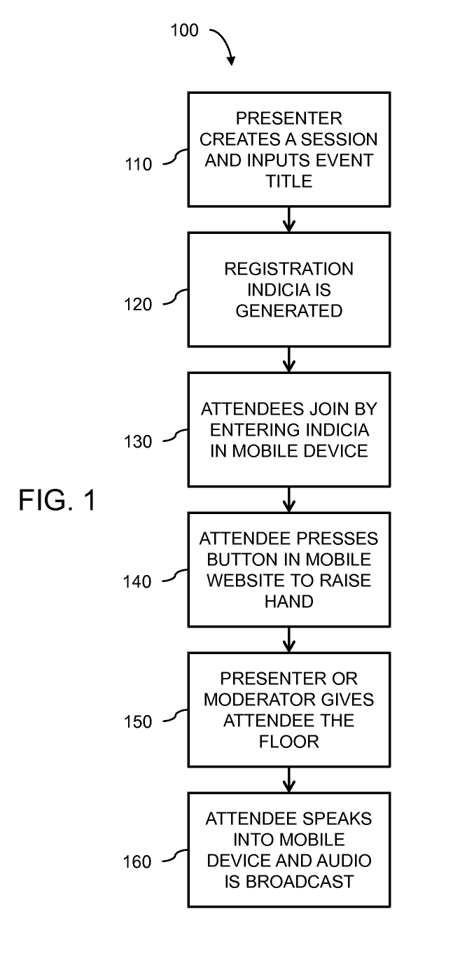

From the presenter's and attendees' perspectives, the sequence of events in registering for and using the conference microphone service is relatively straightforward. In one exemplary sequence of events 100, shown in FIG. 1, the presenter or moderator first creates a session (block 110) on the conference host computer and inputs an event title and a location. A QR code, a TinyURL™ or some other registration indicia is generated (block 120), and is displayed full screen to the conference from the website or copied and pasted into the presenter's slide deck.

The attendees join the session (block 130) using the registration indicia. For example, attendees may scan the QR code displayed on the screen, or enter the TinyURL™ via the smart device keyboard. The address from the registration indicia directs the general purpose browser of the communication device to a Website that is served in association with the particular conference identified by the registration indicia. Through the Website, the attendee enters his or her name and phone number to complete the registration. The Website includes a Web page with a “hand up” button that is used to indicate that a user of the communication device wishes to address the conference by engaging in a real-time communication with the conference, such as asking a question, making a comment or engaging in any other communication that requires an audio or audio/video connection.

When an attendee wants to ask a question, he/she presses the button (block 140) to raise his/her hand which sends a message to the Website server, indicating the “hand up” status of the attendee. One aspect of the presently disclosed technique is that, up to this point in the sequence, no voice connection or dedicated data connection is established between the attendee's smart device and the conference system. Instead, only a few limited data transmissions have taken place.

The presenter or a moderator gives the attendee the floor (block 150) by selecting the attendee from a list that may include several attendees that have “hand up” status. A voice connection is established between the smart phone and the conference system. The attendee then speaks into her phone (block 160) and the audio is immediately transmitted to the conference host computer, which plays the audio on the room's audio public address system, to which the computer is connected.

Another aspect of this technique is that no specialized application software or browser add-ons are necessary to participate in a conference. Instead, the conference registration is performed using a general-purpose browser as is installed on most smart devices, and which is also used in day-to-day tasks not associated with the presently disclosed technique. Similarly, the voice connection is established using general-purpose telephony software installed on the smart device. No specialized application software need be installed on the smart device for the purpose of establishing the voice connection.

As used herein, “general purpose software” is software used to accomplish a class of tasks, such as browsing the Web or establishing a telephone connection. “General purpose software,” as used herein, is not software limited to performing a specific task such as connecting to a particular Web server or using a particular voice connection service.

Operation Details

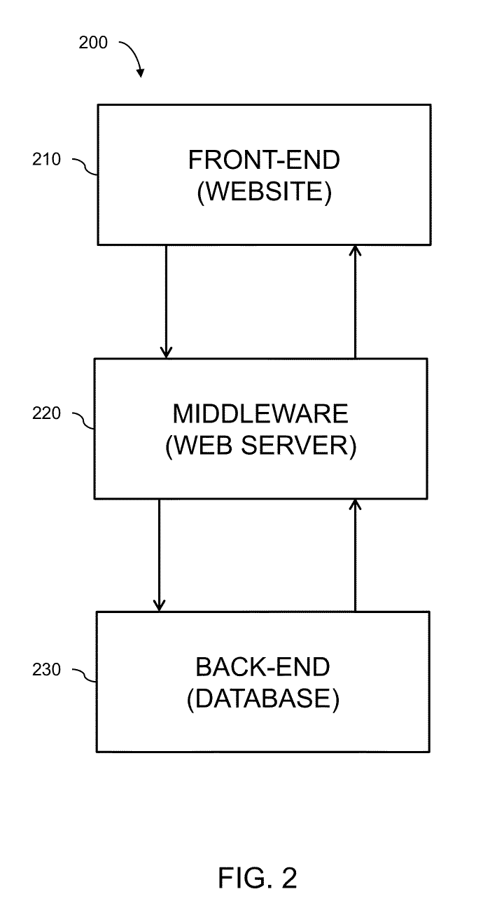

A component block diagram 200, shown in FIG. 2, shows an exemplary arrangement of software modules executing on one or more servers for implementing the presently described technique. A system front-end 210 may comprise a HTML5 Website for interfacing with the moderator or presenter of the conference. In general, the front-end 210 handles interactions with the moderator such as initially setting up the conference, presenting a list of registered attendees to the moderator or presenter, presenting a list of attendees who have electronically “raised their hands” to ask a question or comment, and accepting a selection of one or more of those attendees by the moderator to ask a question or make a comment. The front end additionally acquires registration indicia such as a QR code from a Web service for use by the attendees in registering for the microphone system at the conference.

A middleware component 220 may be implemented using a server-side scripting language such as PHP: Hypertext Processing (PHP), and hosted on a Web server. The middleware component 220 manages data stored on the system back end 230, and interacts with the communications devices during registration and “hand raising.”

The back-end 230 contains a relational database that stores data for one or more events. The data for each event contains records pertaining to individual attendees. The database may be a structured query language (SQL) database such as a database constructed using the MySQL™ open source database language.

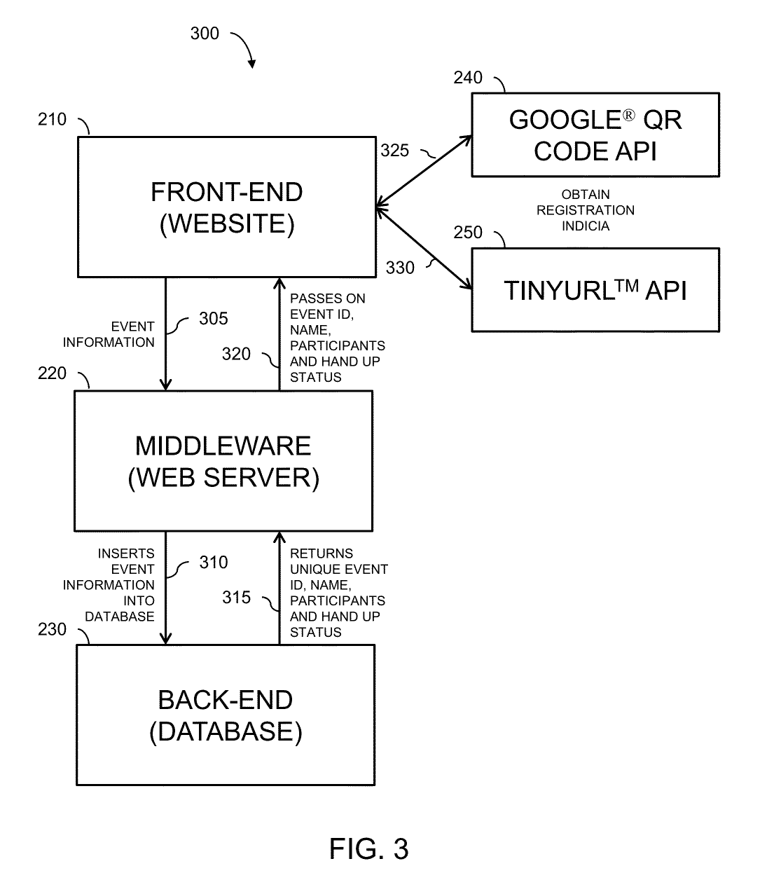

An example sequence of events will now be described in which a conference attendee's personal communications device is used as a microphone for asking questions or making comments during a live conference. During the initial conference event creation, depicted by the flow chart 300 of FIG. 3, event information including an event name, an administrative email and a password are entered at operation 305 by the conference presenter or moderator using the front-end Website 210. In a preferred arrangement, for each of the data exchanges described below, asynchronous data exchange such as that contemplated by the asynchronous JavaScript and XML (AJAX) techniques is used when practical to minimize bandwidth requirements and latency.

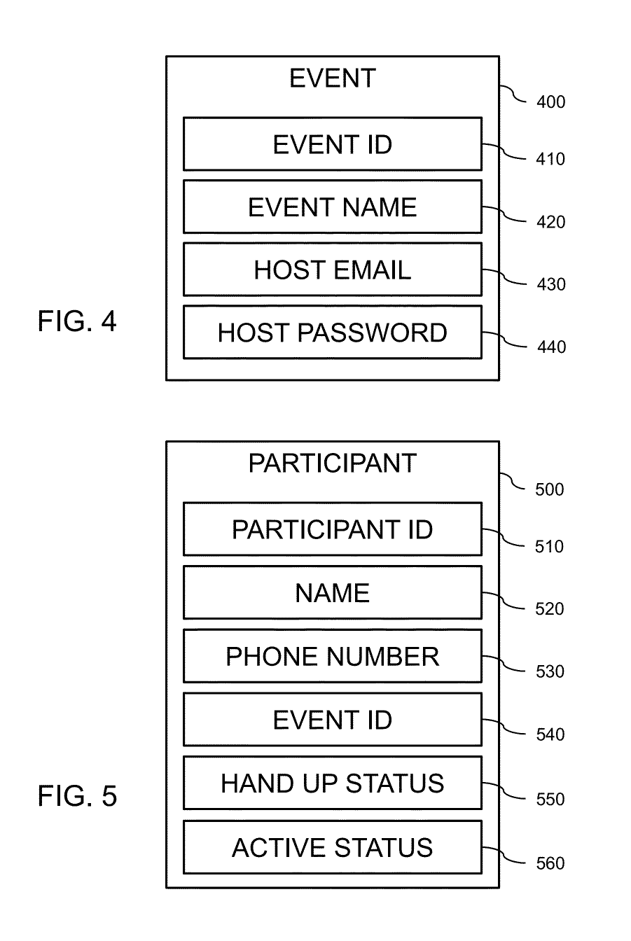

The middleware 220 inserts, at operation 310, the event information into the back-end database 230. A record 400 (FIG. 4) is created in the back-end database 230 when a conference is initiated, and includes a unique event ID field 410 for storing a unique event ID that is generated by the database 230. Also included in the record 400 are an event name field 420, a host email field 430 and a host password field 440. The event information may be entered and the record 400 created in advance of the conference, or may be created on-site as the physical conference is set up.

Returning to FIG. 3, the back end 230 returns, at operation 315, the unique event id, the event name, a list of participants, and each participant's “hand-up” status, as described in more detail below. Initially, information about the participants will be null, and the participant records are added by self-registration. The event ID, the event name, the list of participants and the participants' “hand-up” status are then passed at operation 320 to the front end, where that data is displayed for the presenter's or moderator's use.

A conference attendee uses her personal communication device to register in the system by visiting a Website served by the middleware 220. To facilitate this, the front-end 210 may acquire a streamlined URL input indicium for use by the attendees. The front-end 210 passes, at exemplary operations 325, 330, the URL to be encoded to a Web service such as the Google® QR code API 240 or the TinyURL™ API 250. One skilled in the art will recognize that Web services other than the two examples 240, 250 presented in FIG. 3 are available for encoding a URL, and may be substituted without departing from the spirit or scope of the described invention. The service then returns a registration indicium such as a QR code or a shortened URL for use by the attendees. The indicia may be displayed from the conference host computer directly on the Website, or may be inserted into an electronic presentation slide deck such as a PowerPoint® presentation.

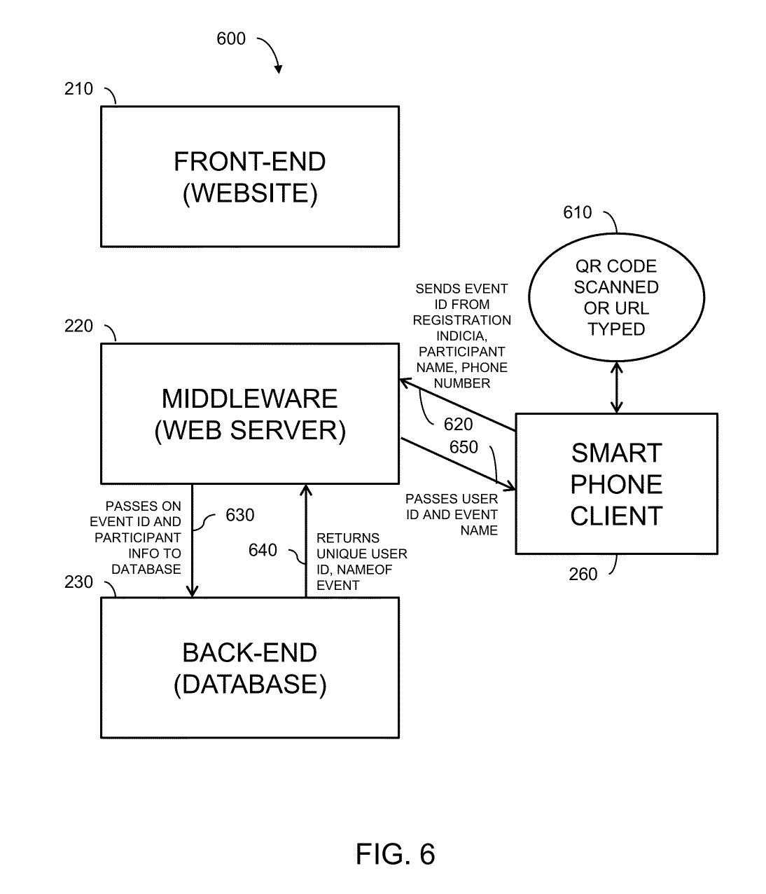

To initiate the registration of a participant in a live conference, as depicted by the flow chart 600 of FIG. 6, the participant directs the general purpose browser of her personal communications device/smart phone client 260 to the URL of a Web site served by the middleware 220. Preferably, the URL is input to the personal communications device using a streamlined browsing technique such as the Google® QR code API 240 or the TinyURL™ API 250 described above with reference to FIG. 3. For example, as represented by the element 610 of FIG. 6, the participant may use the camera on her personal communications device to scan a QR Code displayed on the conference display screen, or may type a displayed TinyURL™ into the device's browser. Alternatively, a standard URL is manually entered via the personal communication device's browser.

The smart phone client 260 is directed to a mobile Website that may, for example, use a touch-optimized web framework such as jQuery Mobile, available from the jQuery Foundation. The QR code or TinyURL™ link includes an embedded event ID, which is captured by the smart phone client 260. The mobile Web site to which the smart phone client is directed additionally gathers a participant name and phone number, either automatically or by providing an interface for the user to manually input that information. The event ID and the participant name and phone number are then transmitted at operation 620 to the middleware 220.

The middleware 220 passes, at operation 630, the event ID and participant information to the back-end database 230, which creates a unique participant ID and saves information about the participant in a new record associated with the participant. An example database record 500 containing information about a particular conference participant, shown in FIG. 5, includes a participant ID field 510, a participant name field 520, a phone number field 530, an event ID field 540, a “hand-up” status field 550 and a field 560 for indicating that the participant is an active speaker. In another embodiment, a separate field 560 for “active” status is not used, and instead, three values (representing “hand up,” “hand down” and “active”) are used in the “hand up” status field 550.

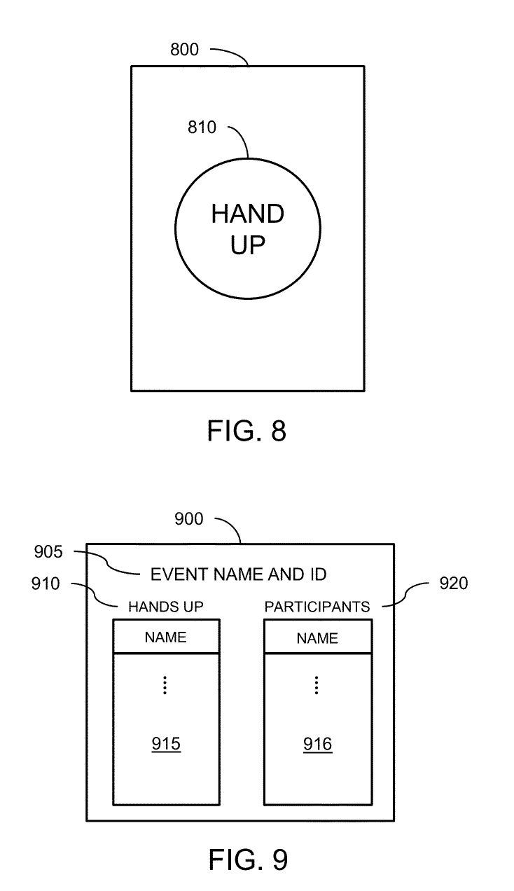

After creating or updating the participant database record 500, the back-end 230 returns, at operation 640 (FIG. 6), the unique participant ID and the name of the event to the middleware 220, which passes, at operation 650, the unique participant ID and the name of the event back to the smart phone client 260. Also transmitted to the smart phone browser as part of the mobile Website are graphics 800, an example of which are shown in FIG. 8, containing a “hand up” button HTML element that, when activated, causes the smart phone client to transmit a “hand up” request as described below. The electronic “hand up” request of the presently described system performs functions paralleling a participant's raising his hand during a conference: it indicates to the presenter or to a moderator that the participant would like to ask a question or comment to the presenter, to be heard by the other conference participants.

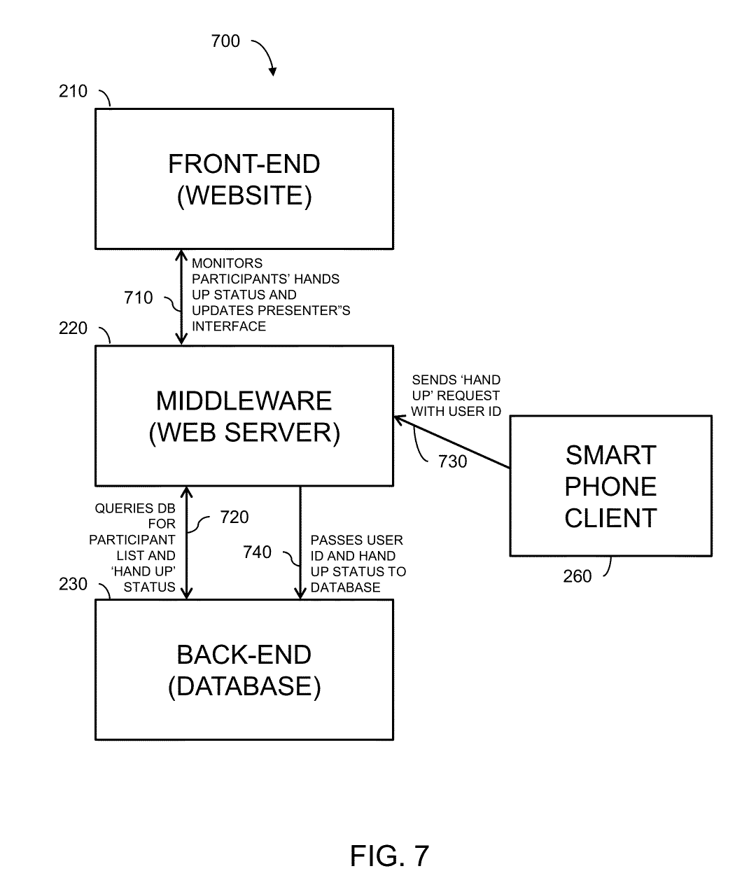

In another sequence of events 700, shown in FIG. 7, a participant figuratively raises his or her hand by transmitting a “hand-up” request. At a regular interval such as every second, the front-end 210 queries the middleware 220 to check, at operation 710, which participants have joined the conference and further to check the “hand up” status of each of the participants. The middleware 220 then queries the database 230, at operation 720, for the current participant list and “hand-up” status, and the database returns that information. The front end 210 then updates the presenter's graphical interface based on the data that the middleware 220 returns. An example interface 900 is shown in FIG. 9. The event name and event ID are displayed in a heading 905. A table 920 contains a scrollable list of participant names 916, which may be color coded according to “hand-up” status. A separate displayed table 910 may list those participant names 915 having indicated “hand-up” status. The participant names 915 may be sorted in the table 910 according to the order in which the “hand up” requests are received. In another embodiment, the table 910 may contain a status time (not shown) for each participant, indicating how long the participant has had his hand up.

When a participant activates the “hand-up” button 810 (FIG. 8), the smart phone client sends to the middleware 220 a request 730 (FIG. 7) to change the status of the participant to “hand-up.” No voice connection is necessary in transmitting the request, and no voice connection exists at this point between the smart phone client 260 and the front end 210. The request includes the participant ID. Activating the button 810 may toggle it between a “hand-up” button and a “hand down” button. In that way, a participant can rescind a hand-up request. For example, a participant having a question activates the “hand-up” button. After some additional conference proceedings, the participant realizes that her question has been answered by the presenter, and activates the “hand-down” button to change her status from “hand-up” to “hand-down.”

The middleware 220 passes, at operation 740, the “hand up” request and the participant ID to the database 230. The status of the participant is changed in the database by toggling the flag in the “hand up” status field 550 (FIG. 5). The changed status is reflected in the next query response 720 to the middleware 220.

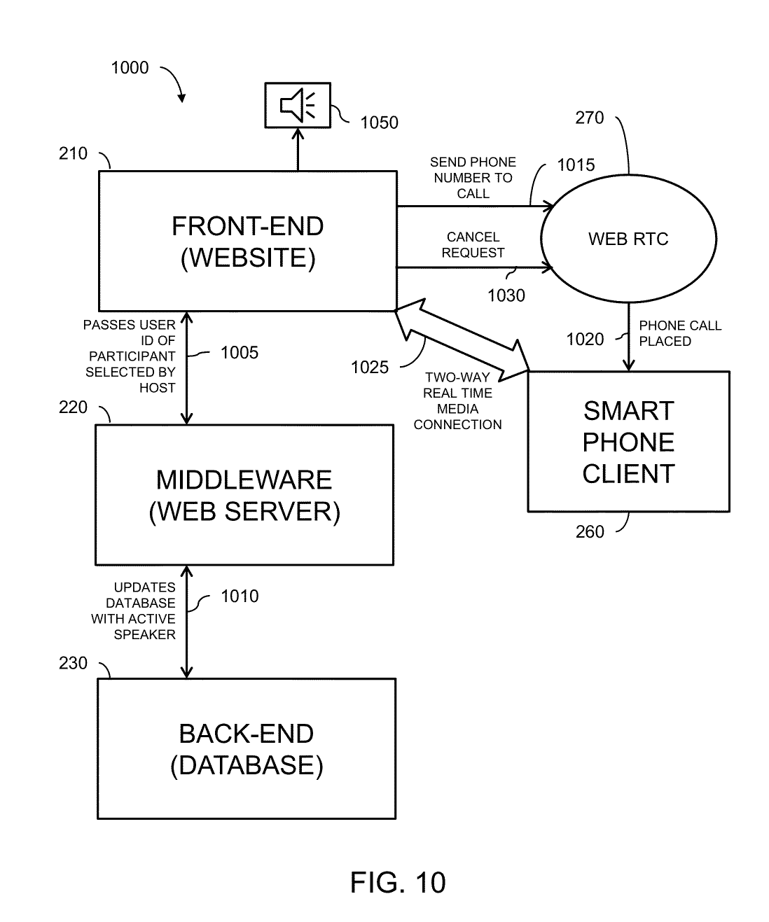

The presenter or moderator can now “call on” a conference participant by selecting that participant from a list of participants with “hand up” status, as depicted in the sequence 1000 shown in FIG. 10. The presenter or moderator makes a selection using the graphical interface 900 (FIG. 9) from the list of participants 910 having a “hand up” status. Again, no voice connection exists at this point between the smart phone client 260 and the front-end 210. The front end 210 (FIG. 10) passes, at operation 1005, the participant ID of the selected participant to the middleware 220, which requests the database 230 to mark the participant as active at operation 1010, by toggling a flag in the active field 560 (FIG. 5). The database 230 responds with an updated status of the active speaker, including a telephone number of the mobile communications device used in registering for the conference. Once the selection of the participant is reflected in the database 230, the information is passed via the middleware 220 to the front end 210, which updates the interface 900 to show that the participant as active; for example, the active participant may be highlighted with a special font or color.

The front end 210 transmits, at operation 1015, the telephone number of the selected participant to a Web service that provides real-time communications on the Web. In a preferred arrangement, an AT&T application programming interface (API) is used to access WebRTC browser-based real-time communication capability.

Using the WebRTC capability, a phone call is placed at operation 1020 to the telephone number associated with the smart phone client 260. When the call is answered, a two way audio or audio/video connection 1025 is established between the front end computer 210 and the smart phone client 260. The connection 1025 is made only for the time during which the conference attendee “has the floor”; i.e., after the presenter selects the attendee and before the call is terminated. Until the attendee is selected to “have the floor,” although the attendee is registered with the conference microphone service, no connection is established with the smart phone client. Instead, only minimal data exchanges take place during registration and when the attendee “raises her hand.” Because voice connections are made only with attendees who are actively speaking, the presently described system utilizes minimal bandwidth and is highly scalable.

In a preferred embodiment, the communication capability requires no pre-stalled software applications or browser add-ons. Instead, a general purpose browser and general purpose telephony software are used to establish the telephone connection 1025.

The front end computer is connected to the conference speaker system 1050 in the same way a computer would typically be connected to play audio or video from the computer. The conference speaker system may be a public address broadcast system. The content of the audio or audio/video connection is broadcast to the conference attendees via the speaker system 1050. For example, in the case of an audio connection, the selected participant can be heard by all conference attendees as the participant asks a question or makes a comment. Additionally, if the conference audio or other content is being transmitted to remote sites, or is being sent to a recording file, the selected participant's questions or comments are included in that content as well.

The connection 1025 can additionally be extended to one or more additional conference participants by repeating the operations 1005, 1010, 1015 for additional conference participants, effectively creating a conference call with one of the connections being to the front-end computer 210. For example, two or more audience members may carry on an impromptu panel discussion that is broadcast to the conference. To accomplish that, the moderator selects additional attendees from the list, without terminating previously-made connections. The audio of all participants on the call is broadcast over the speaker system.

The conference presenter or moderator maintains control of the discussion because he has the ability to disconnect the call by sending a cancel request 1030 from the front-end to the WebRTC service 270, which, in response, disconnects the media connection 1025. The connection 1025 may alternatively be terminated by the participant, by simply hanging up the phone.

System

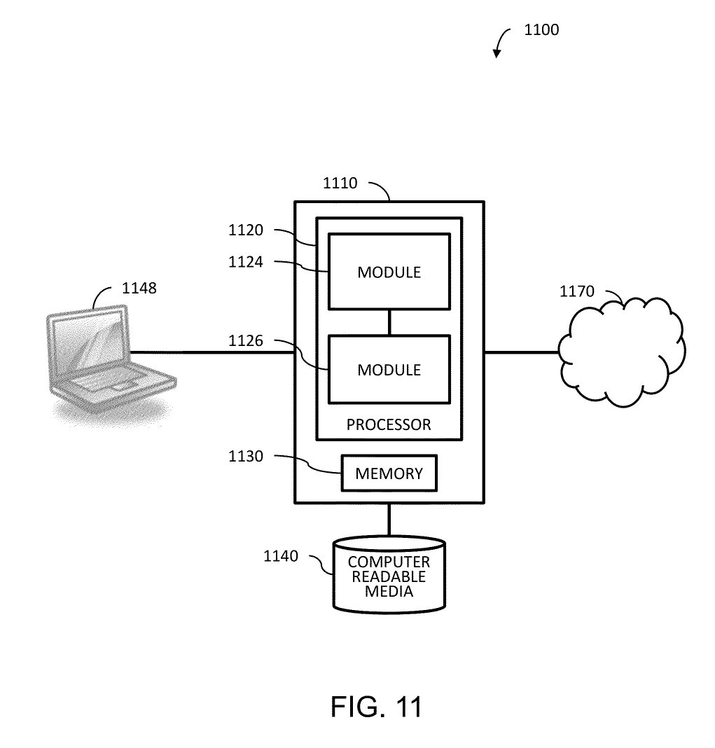

The elements of the methodology as described above may be implemented in a computer system comprising a single unit or a plurality of units linked by a network or a bus. In one example, the elements of the system 200 depicted in FIG. 2, including a Website front-end 210, middleware 220 running on a Web server, and a database back-end 230, may each, collectively or individually, be instantiated using a computing system such as the exemplary computing system 1100 is shown in FIG. 11.

A computing apparatus 1110 may be a mainframe computer, a desktop or laptop computer or any other device or group of devices capable of processing data. The computing apparatus 1110 receives data from any number of data sources that may be connected to the apparatus. For example, the computing apparatus 1110 may receive input from a user via an input/output device 1148, such as a computer or a computing terminal. The input/output device includes an input that may be a mouse, network interface, touch screen, etc., and an output that may be a visual display screen, a printer, etc. Input/output data may be passed between the computing apparatus 1110 and the input/output device 1148 via a wide area network such as the Internet, via a local area network or via a direct bus connection. The computing apparatus 1110 may be configured to operate and display information by using, e.g., the input/output device 1148 to execute certain tasks.

The computing apparatus 1110 includes one or more processors 1120 such as a central processing unit (CPU) and further includes a memory 1130. The processor 1120, when configured using software according to the present disclosure, includes modules 1124, 1126 that are configured for performing one or more operations, as discussed herein.

The memory 1130 may include a random access memory (RAM) and a non-volatile memory such as an electrically erasable programmable read-only memory (EEPROM). The memory may also include removable media such as a disk drive, tape drive, memory card, etc., or a combination thereof. The RAM functions as a data memory that stores data used during execution of programs in the processor 1120; the RAM is also used as a program work area. The EEPROM functions as a program memory for storing a program executed in the processor 1120. The program may reside on the EEPROM or on any other tangible, non-volatile computer-readable media 1140 as computer readable instructions stored thereon for execution by the processor to perform the operations of the invention.

Generally, the modules 1124, 1126 include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like. The disclosed technique may also be employed in distributed computing environments, where tasks are performed by remote processing devices that are linked through a communications network. In a distributed computing environment, modules may be located in both local and remote memory storage devices.

An exemplary processing module for implementing the methodology above may be hardwired or stored in a separate memory that is read into a main memory of a processor or a plurality of processors from a computer readable medium such as a ROM or other type of hard magnetic drive, optical storage, tape or flash memory. In the case of a program stored in a memory media, execution of sequences of instructions in the module causes the processor to perform the process operations described herein. The embodiments of the present disclosure are not limited to any specific combination of hardware and software and the computer program code required to implement the foregoing can be developed by a person of ordinary skill in the art.

The term “computer-readable medium” as employed herein refers to a tangible, non-transitory machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. The terms “tangible media” and “non-transitory media” each exclude propagated signals, which are not tangible and are not non-transitory. Cached information is considered to be stored on a computer-readable medium. Common expedients of computer-readable media are well-known in the art and need not be described in detail here.

### CONCLUSION

The above described solution offers a technique for the use of a personal communications device such as a smart phone as a microphone to ask questions or make comments that can be heard over a public address system by attendees of a conference. The solution is cheaper and more portable than the existing hardware-based wireless microphone systems that are currently used for that purpose. It is also more convenient, in that nearly everyone in the conference room effectively has a microphone, and for those who don't, the host can provide several mobile devices with the subject application that can be passed around.

Previously used techniques for communicating with a conference host require a continuous connection (voice and/or data) between the host and the participants. While that makes sense for the purpose of virtual conferences where the connection is necessary to continuously hear the audio from the presenter, it is not a good solution for people attending a conference in person, where the audio is heard via a speaker system, and where a continuous connection would therefore waste wireless plan minutes, data usage and battery life during periods when the attendee is not asking a question.

Another advantage of the presently described system is that it works without any prior installation or information sent to the smartphone before an event, and is compatible with any smartphone that has a browser.

The described solution may be expanded to stream video from the mobile device's front-facing camera. In that case, for hybrid real-world/webcast events or exclusively webcast events, an audio/video signal depicting a participant asking a question or making a comment can be streamed to other participants' browsers. Optionally, a title bar with the participant's name and title may be overlaid on the feed. The presently described technique may be included as an embedded feature in an event application that facilitates other aspects of event management, such as event registration, event scheduling, event materials distribution and event marketing. In one embodiment, each attendee has an event app installed on his smart device for displaying an event's schedule, etc. The app provider additionally includes the presently described technology as part of that package. Registration for the presently described microphone service may be combined with registration for the event, reducing the overall burden in registering for the event.

The forgoing detailed description is to be understood as being in every respect illustrative and exemplary, but not restrictive, and the scope of the disclosure herein is not to be determined from the description, but rather from the claims as interpreted according to the full breadth permitted by the patent laws. It is to be understood that various modifications will be implemented by those skilled in the art, without departing from the scope and spirit of the disclosure.

What is claimed is:

1. A method of broadcasting audio from a selected personal communications device through a speaker system, comprising:
before establishing a voice connection with the selected personal communications device, receiving, from each of a plurality of personal communications devices, a separate request to broadcast audio through the speaker system;
before establishing the voice connection with the selected personal communications device, receiving, from a conference host computer, a selection identifying the selected personal communications device from among the plurality of personal communications devices;
in response to receiving the selection, establishing the voice connection between the conference host computer and the selected personal communications device; and
broadcasting through the speaker system, audio received via the voice connection.

2. The method of claim 1 wherein the voice connection is established using a telephone number associated with the selected personal communications device.

3. The method of claim 1 wherein software installed on the personal communications device that is used in generating the request to address the conference is limited to a general purpose Web browser.

4. The method of claim 1 wherein:
software installed on the personal communications device that is used in establishing the voice connection is limited to general purpose telephony software and a general purpose Web browser; and
software installed on the conference host computer that is used in establishing the voice connection is limited to a general purpose Web browser.

5. The method of claim 1 further comprising:
providing a conference identifier to be input into each of the plurality of the personal communications devices;
receiving, from each of the plurality of personal communications devices, a separate request to join the conference, the request including the conference identifier and an identification of the personal communications device; and
in response to receiving the separate request to join the conference from each of the plurality of personal communications devices:
transmitting to the personal communications device an HTML element for making a request to address the conference; and
creating in a database a record corresponding to the personal communications device.

6. The method of claim 5, wherein providing a conference identifier comprises visually presenting a two dimensional bar code that, when scanned using a personal communications device, points a browser of the personal communications device to a Web page associated with the conference.

7. The method of claim 5, further comprising:
in response to receiving each request to address the conference, setting a flag in a record of the database corresponding to the requesting personal communications device.

8. The method of claim 7, further comprising:
presenting via the conference host computer a list of records of the database containing a flag indicating a request to address the conference.

9. The method of claim 8, wherein the list of records is in an order in which the requests to address the conference were received.

10. The method of claim 5, wherein the identification of the personal communications device is a telephone number associated with the personal communications device.

11. A non-transitory computer-usable medium having computer readable instructions stored thereon that, when executed by a processor, cause the processor to perform operations for broadcasting audio from a selected personal communications device through a speaker system, the operations comprising:
before establishing a voice connection with the selected personal communications device, receiving, from each of a plurality of personal communications devices, a separate request to broadcast audio through the speaker system;
before establishing the voice connection with the selected personal communications device, receiving, from a conference host computer, a selection identifying the selected personal communications device from among the plurality of personal communications devices;
in response to receiving the selection, establishing the voice connection between the conference host computer and the selected personal communications device; and
broadcasting through the speaker system, audio received via the voice connection.

12. The non-transitory computer-usable medium of claim 11, wherein the voice connection is established using a telephone number associated with the selected personal communications device.

13. The non-transitory computer-usable medium of claim 11, wherein software installed on the personal communications device that is used in generating the request to address the conference is limited to a general purpose Web browser.

14. The non-transitory computer-usable medium of claim 11, wherein:
software installed on the personal communications device that is used in establishing the voice connection is limited to general purpose telephony software and a general purpose Web browser; and
software installed on the conference host computer that is used in establishing the voice connection is limited to a general purpose Web browser.

15. The non-transitory computer-usable medium of claim 11, wherein the operations further comprise:
providing a conference identifier to be input into each of the plurality of the personal communications devices;
receiving, from each of the plurality of personal communications devices, a separate request to join the conference, the request including the conference identifier and an identification of the personal communications device; and
in response to receiving the separate request to join the conference from each of the plurality of personal communications devices:
transmitting to the personal communications device an HTML element for making a request to address the conference; and
creating in a database a record corresponding to the personal communications device.

16. The non-transitory computer-usable medium of claim 15, wherein providing a conference identifier comprises visually presenting a two dimensional bar code that, when scanned using a personal communications device, points a browser of the personal communications device to a Web page associated with the conference.

17. The non-transitory computer-usable medium of claim 15, wherein the operations further comprise:
in response to receiving each request to address the conference, setting a flag in a record of the database corresponding to the requesting personal communications device.

18. The non-transitory computer-usable medium of claim 17, wherein the operations further comprise:
presenting via the conference host computer a list of records of the database containing a flag indicating a request to address the conference.

19. A system for broadcasting audio from a selected personal communications device through a speaker system, comprising:
a network server including a processor;
an audio interface for transmitting signals to be broadcast via a speaker system;
a network interface; and
a non-transitory computer-usable medium having computer readable instructions stored thereon that, when executed by the processor, cause the processor to perform operations comprising:
before establishing a voice connection with the selected personal communications device, receiving via the network interface, from each of a plurality of personal communications devices, a separate request to broadcast audio via the speaker system;
before establishing the voice connection with the selected personal communications device, receiving, from a conference host computer via the network interface, a selection identifying the selected personal communications device from among the plurality of personal communications devices;
in response to receiving the selection, establishing via the network interface the voice connection between the conference host computer and the selected personal communications device; and
broadcasting via the audio interface, audio received via the voice connection.

20. The system of claim 19, wherein the operations further comprise:
providing a conference identifier to be input into each of the plurality of the personal communications devices;
receiving, from each of the plurality of personal communications devices, a separate request to join the conference, the request including the conference identifier and an identification of the personal communications device; and
in response to receiving the separate request to join the conference from each of the plurality of personal communications devices:
transmitting to the personal communications device an HTML element for making a request to address the conference; and
creating in a database a record corresponding to the personal communications device.
